(19) United States
(12) Patent Application Publication
(10) Pub. No.: US 2025/0346466 A1
(43) Pub. Date: Nov. 13, 2025

(54) Truck Rack Lifter Assembly and Quick Release System

(71) Applicant: Raidho Outfitters LLC, Fountain Valley, CA (US)

(72) Inventor: Austin Lopez, Fountain Valley, CA (US)

(21) Appl. No.: 19/201,910

(22) Filed: May 7, 2025

Related U.S. Application Data
(60) Provisional application No. 63/643,912, filed on May 7, 2024.

(51) Int. Cl. B66F 7/26; B60R 9/045

(52) U.S. Cl. CPC B66F 7/26; B60R 9/045

(57) ABSTRACT

Various systems and apparatus are disclosed for lifting, securing, and releasing a truck rack from a truck, car, SUV or automobile. In some embodiments, a lifter assembly is disclosed. In some embodiments, a lever assembly is disclosed. In some embodiments, a quick release system is disclosed. In some embodiments, a quick release pin is disclosed.

### SUMMARY

Various systems and apparatus are disclosed for lifting, securing, and releasing a truck rack from a truck, car, SUV or automobile. In some embodiments, a lifter assembly is disclosed. In some embodiments, a lever assembly is disclosed. In some embodiments, a quick release system is disclosed. In some embodiments, a quick release pin is disclosed.

For example, a truck rack lifter assembly may include an assembly frame; one or more wheels coupled with the assembly frame; and a plurality of lifter mechanisms coupled with the frame that are arranged to couple with a truck rack and lift the truck rack vertically.

For example, a lever assembly may include a vertical member; a slider body; a horizontal support member; a lifter arm having tapered end, the lifter arm coupled with the slider body; an angled support member coupled with the vertical member and the horizontal support member at a first attachment point; a first lever arm rotatably coupled with the angled support member and the horizontal support member at the first attachment point, the first lever arm is coupled with the tapered end of the lifter arm; and a second lever arm coupled with a first lever arm at a second attachment point.

### BRIEF DESCRIPTION OF THE FIGURES

FIG. 1 is an illustration of an example lifter assembly with a load comprising a truck bed rack and a tent.

FIG. 2 is an illustration of an example lifter assembly with a load comprising a truck bed rack with the tent removed.

FIG. 3 is an illustration of an example base for a lifter assembly.

FIG. 4 is an illustration of another example base for a lifter assembly.

FIG. 5 is an exploded view of portions of a base unit and a lifter assembly.

FIG. 6 is an illustration of an example lifter assembly with an extension unit.

FIGS. 7A,7B, and 7C are show an example lifting arm and lifting unit connector.

FIG. 8A and FIG. 8B are illustrations of an example lever assembly.

FIG. 9 is an illustration of a truck bed rail system with a truck bed rack.

FIG. 10A is a side view illustration of an example quick lift system.

FIG. 10B is a side view illustration of an example lift release system.

FIG. 11 is a side view illustration of an example lift release system.

FIG. 12 is a top view illustration of an example lift release system.

FIG. 13 is an illustration of an example quick release pin system with a truck bed rail.

FIG. 14 is an image of an example quick release system used with a truck bed rail.

FIG. 15 is an image of an example quick release system.

### DETAILED DESCRIPTION

A truck rack lifter assembly is disclosed. Various truck rack systems are available that mount to the sides of a truck bed. These truck rack systems include, for example, tents, cargo racks, bed racks, truck bed toppers, etc. Truck rack systems can be heavy and cumbersome and, therefore, difficult to remove or install. A truck rack lifter assembly may provide a simple way to remove and/or store a truck rack system.

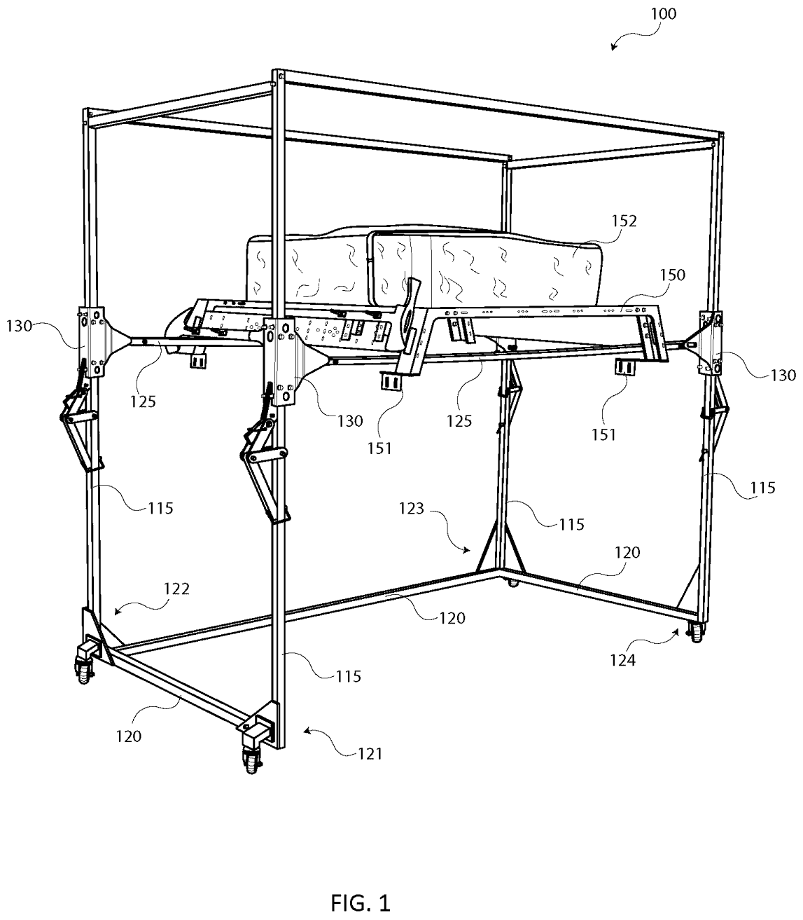

FIG. 1 is an illustration of an example lifter assembly 100 with a load. The lifter assembly 100, for example, may include four vertical members 115 and at least three base members 120. The base members 120 coupled with the bottom of the four vertical members 115. The four vertical members 115 extend vertically from ends of the base members 120. The three base members 120 form a rectangular shaped base.

At a first bottom corner 121, a single base member 120 may be perpendicularly coupled with a single one of the four vertical members 115. The first bottom corner 121 may include a bracket or v to strengthen the coupling of the single base member 120 and the vertical member 115. The first bottom corner 121 may also be coupled with a wheel that may or may not include a break and/or may or may not be levered upward and downward.

At a second bottom corner 122, two base members 120 may be perpendicularly coupled with a single one of the four vertical members 115. The second bottom corner 122 may include a bracket or brace to strengthen the coupling between each of the two base members 120 and the vertical member 115. The second bottom corner 122 may also be coupled with a wheel that may or may not include a break and/or may or may not be levered upward and downward.

At a third bottom corner 123, two base members 120 may be perpendicularly coupled with a single one of the four vertical members 115. The third bottom corner 123 may include a bracket or brace to strengthen the coupling between each of the two base members 120 and the vertical member 115. The third bottom corner 123 may also be coupled with a wheel that may or may not include a break and/or may or may not be levered upward and downward.

At a fourth bottom corner 124, a single base member 120 may be perpendicularly coupled with a single one of the four vertical members 115. The fourth bottom corner 124 may include a bracket or brace to strengthen the coupling of the single base member 120 and the vertical member 115. The fourth bottom corner 124 may also be coupled with a wheel that may or may not include a break and/or may or may not be levered upward and downward.

Each of two cross members 125 are coupled with respective ones of the four vertical members 115 via lever assembly slider body 130. A lever assembly slider body 130 can be used to raise and lower the two cross members 125. The lever assembly slider body 130, for example, can move an end of one of the two cross members 125 about four, six, eight, ten, twelve, etc. inches relative to one of the four vertical members 115. Each lever assembly slider body 130, for example, may be moveable along the length of a respective one of the four vertical members 115.

The two cross members 125, for example, may support the load 150. In this example, the load includes a truck rack 150 with a tent 152. Any kind of load may be lifted.

The four vertical members 115 may or may not extend above the lever assembly slider body 130.

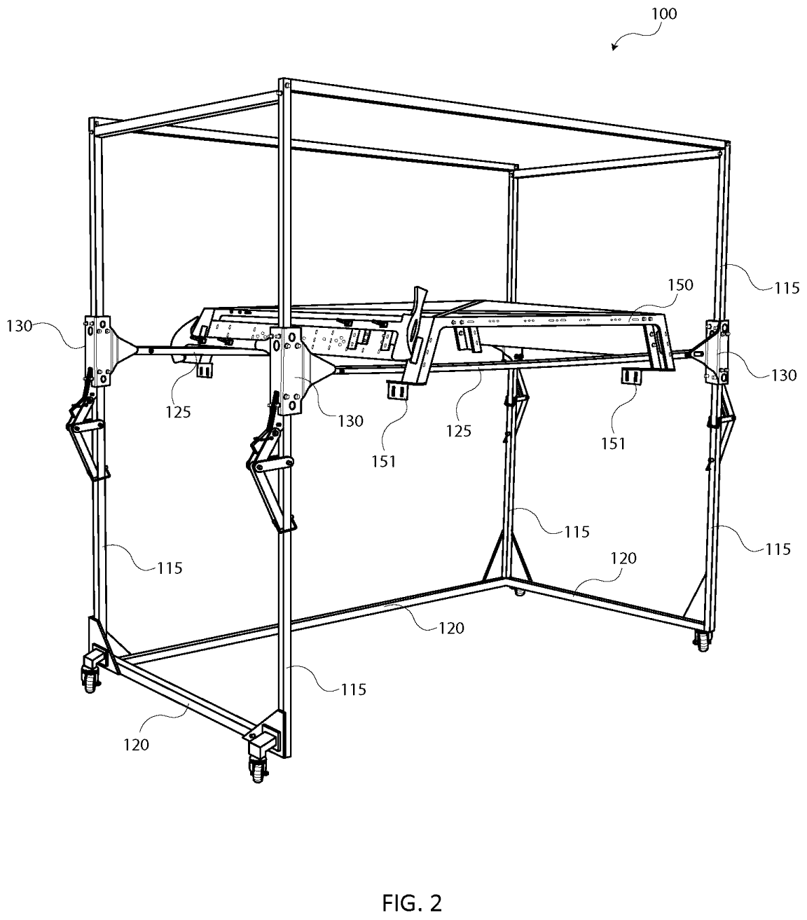

FIG. 2 is an illustration of the lifter assembly 100 without the load 152.

The lifter assembly 100 may or may not include the upper portions of the vertical member 115 such as, for example, the portions of the vertical member 115 above the lever assembly slider body 130 and/or the upper cross members shown in the figures.

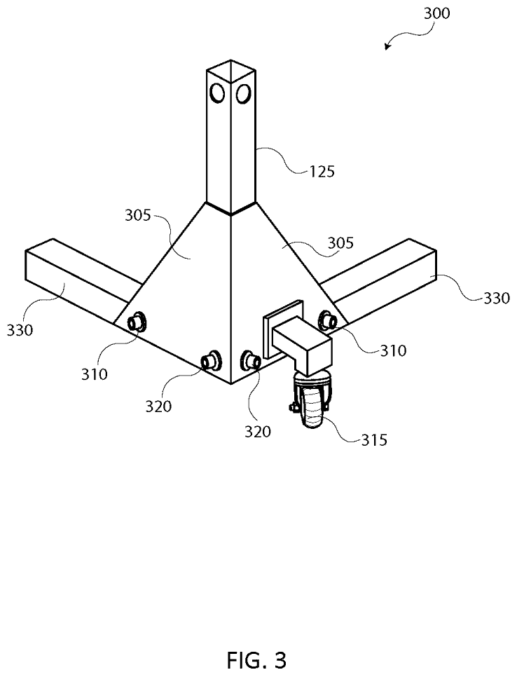

FIG. 3 is an illustration of an example bottom corner 300 for a lifter assembly 100. Any of the first bottom corner 121, the second bottom corner 122, the third bottom corner 123, and/or the fourth bottom corner 124 may comprise the bottom corner 300. The bottom corner 300 may include bracket 305 that may be triangular shaped and/or may be coupled between a base member 330 and a vertical member 115. The bottom corner 300 may be coupled with a wheel assembly 315.

Each of the base members 120 may be coupled with the bracket 305 with a removable pin 310 and a pivot pin 320. The bottom corner 300 may be disassembled by removing the removable pin 310 whereupon the single base member 120 may be rotated upward around the pivot pin 320. As another example, base member 330 and single base member 120 may be combined into a singular telescoping leg with removable pins.

The vertical member 115, for example, may include a vertical member 115. The vertical member 115, for example, may couple with the vertical member 115.

The base member 330, for example, may include the base member 120. The base member 330, for example, may couple with the base member 120 and/or the base member 330 and the single base member 120 may comprise a single telescoping unit.

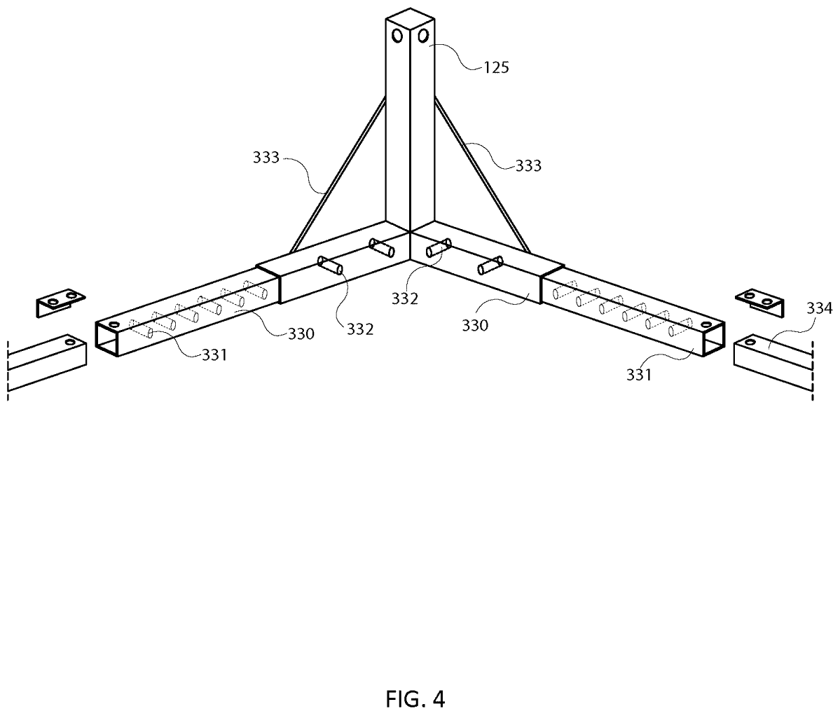

FIG. 4 is an illustration of another example base for a lifter assembly. In this example, the base may be collapsible (or telescoping). For example, the base member 330 may include extendable members 331 that can telescope from within the base member 330. The extendable members 331 may have a series of transverse holes along the length of the extendable members 331 and the base member 330 may have one or more transverse holes. A pin 332 may be inserted through the hole in the base member 330 and through one of the holes in the extendable members 331, which may secure the base member 330 with the extendable members 331.

A mating plate 334 with one or more holes may be used to secure one extendable members 331 with another extendable members 331.

The base may include hinged supports 333 that extend between the vertical member 115 and each base member 330. Each base member 330, for example, may pivot from the bottom of the vertical member 115 and rotate upwards to align with the vertical member 115.

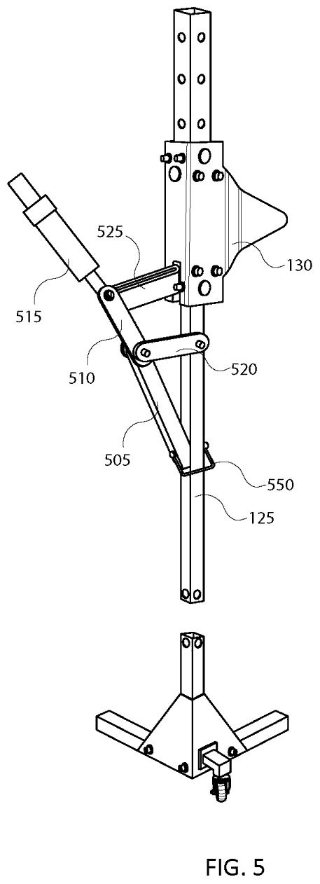

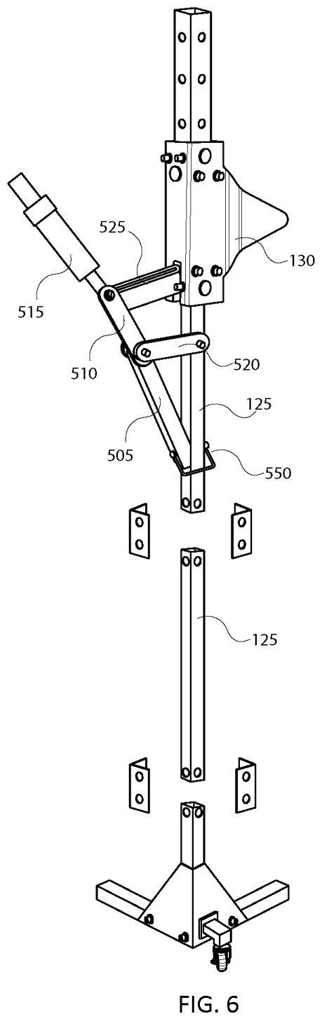

FIG. 5 is an exploded view of a portion of an example lifter assembly. FIG. 6 is an illustration of an example lifter assembly with an extension unit.

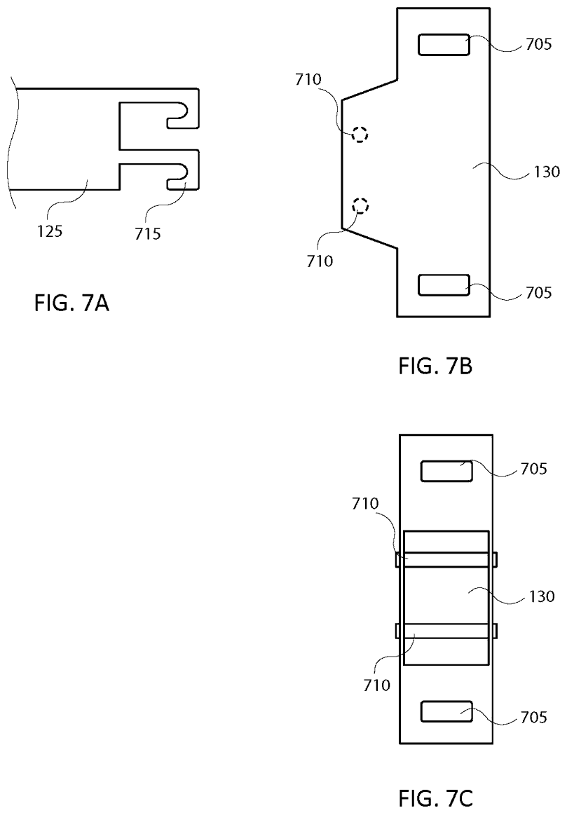

FIG. 7A in an illustration of an example connector assembly end for a cross member 125. FIG. 7B and FIG. 7C are front and side illustrations of an example quick release assembly for the lever assembly slider body 130. Both ends of a cross member 125 may have one or more hooks 715 that extend from the end for the cross member 125. These hook 715 may be sized and shaped to engage with pins 710 arranged within the lever assembly slider body 130.

The lever assembly slider body 130 may also include a plurality of bearings 705. These bearings 705, for example, may be cylindrical bearings. The plurality of bearings 705 may engage between the lever assembly slider body 130 and a vertical member 115 allowing the lever assembly slider body 130 to slide upwards and downwards along the vertical member 115. In some examples, the lever assembly slider body 130 may include two sets of bearings on each side of the lever assembly slider body 130 or a total of eight or sixteen bearings. Two bearings, for example, may be coupled with an axel that extends across the lever assembly slider body 130.

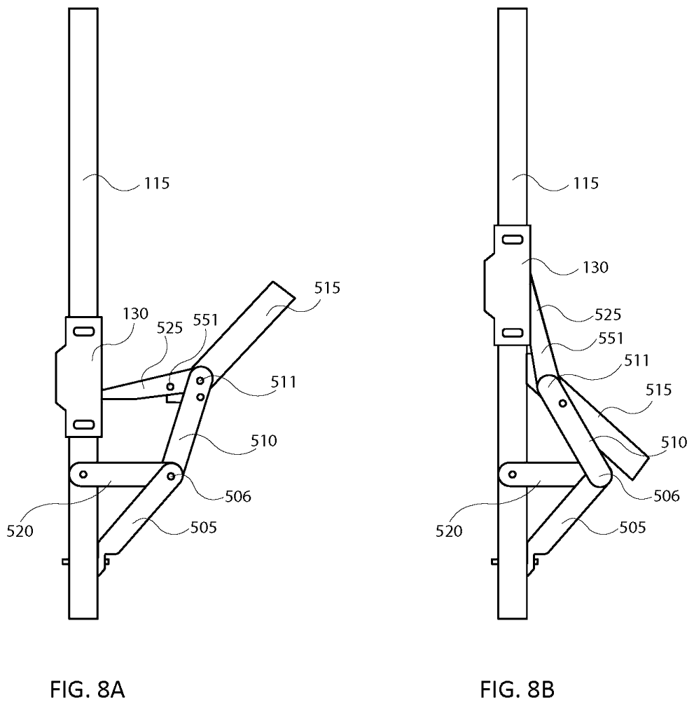

FIG. 8A and FIG. 8B are side view illustrations of an example lever assembly. A lever assembly, for example, may allow a user to slide a lever assembly slider body 130 upwards and downwards a set distance along a vertical member 115.

The lever assembly, for example, may be especially operable to move a load coupled with the lever assembly slider body 130 between two vertical positions with minimal effort from a user and/or allow the user to lock the lever assembly slider body 130 in place between an upper position and a lower position.

A lever assembly, for example, may include an angled support member 505 coupled with a vertical member 115 and a horizontal support member 520 at a first attachment point 506. The horizontal support member 520 may also be coupled with the vertical member 115. A first lever arm 510 may be rotatably coupled with the angled support member 505 and the horizontal support member 520 at the first attachment point 506. The first lever arm 510 may be coupled with a tapered end of the lifter arm 525 and a second lever arm 515 at a second attachment point 511. The lifter arm 525 may be coupled with the lever assembly slider body 130. The lifter arm 525 may include a pin 551. The pin 551 may be a pin or bolt that extends across two members of the lifter arm 525, a detent, or the like.

The lifter arm 525 may have a tapered end with a hole. An axel, bolt, or pin passing through the lever assembly slider body 130 may pass through the hole in the lifter arm 525. The axel, bolt and/or pin, for example, may also be coupled with one or more of the bearings.

The first lever arm 510 is rotatably coupled with both the first attachment point 506 and the second attachment point 511. The second lever arm 515 is coupled with the lifter arm 525 about the second attachment point 511 such that when the distal end of the second lever arm 515 (the end not coupled with the second attachment point 511) is rotated downward (clockwise in the figures), a portion of the proximal end of the second lever arm 515 engage the lifter arm 525 and/or rotate around the second attachment point 511 such that the proximal end of the lifter arm 525 (the end coupled with the lever assembly slider body 130) lifts the lever assembly slider body 130 upwards along the vertical member 115.

The first lever arm 510 and the second lever arm 515 may have holes that are aligned when the lever assembly is in the upward position. A pin may be manually slide through these holes locking the assembly into position.

The proximal end of the second lever arm 515 may be angled such that when the lever assembly is in the upward position, the angled portion of the proximal end of the second lever arm 515 may be aligned with and abutting the vertical member 115.

The second lever arm 515 and the lifter arm 525 may comprise a single piece.

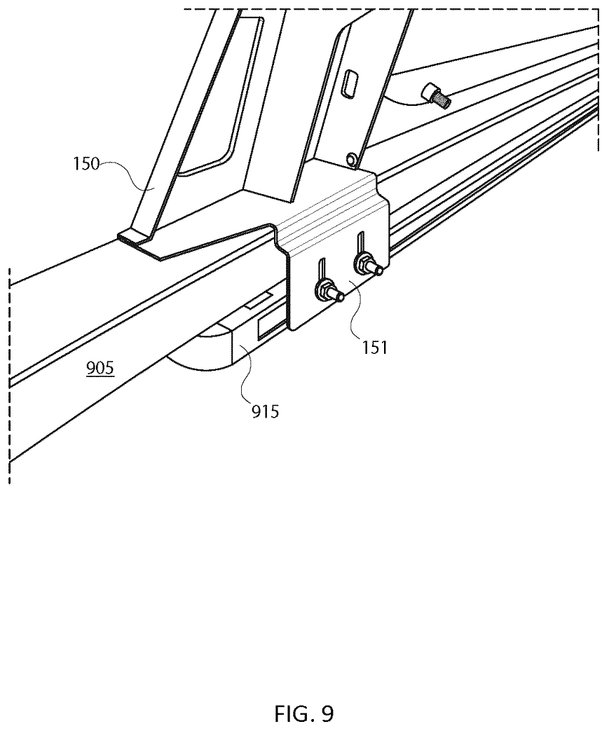

A truck rack is shown in FIG. 9. A truck bed rail 915 in a truck bed rack 150 is shown. The truck bed rack 150 includes a bracket 151 that couples with the truck bed rail 915 of a truck bed 905. Bolts may be used to couple the bracket 151 with the truck bed rail 915. Removal of the truck bed rack 150 can be time consuming and/or difficult when multiple bolts must be removed before lifting the truck bed rack 150 off the bed of the truck.

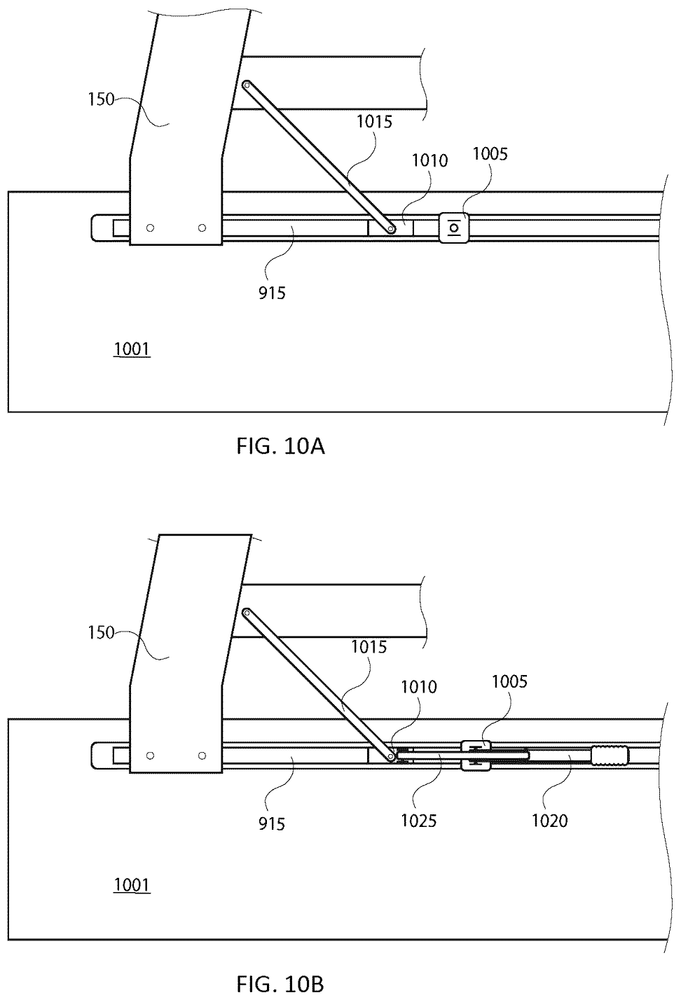

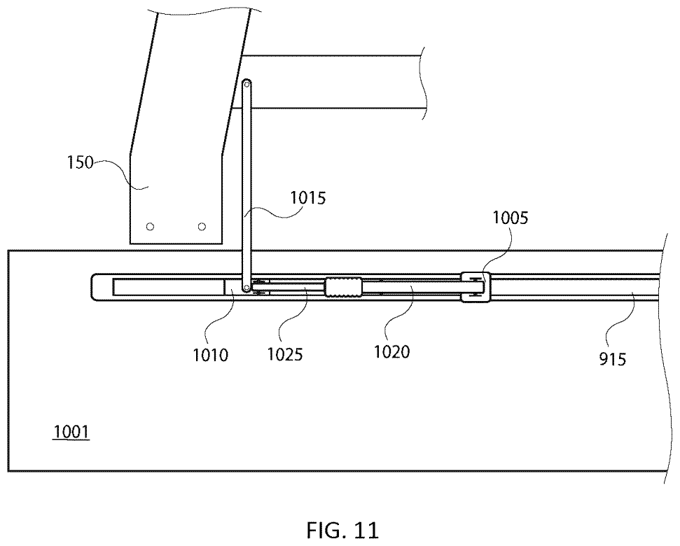

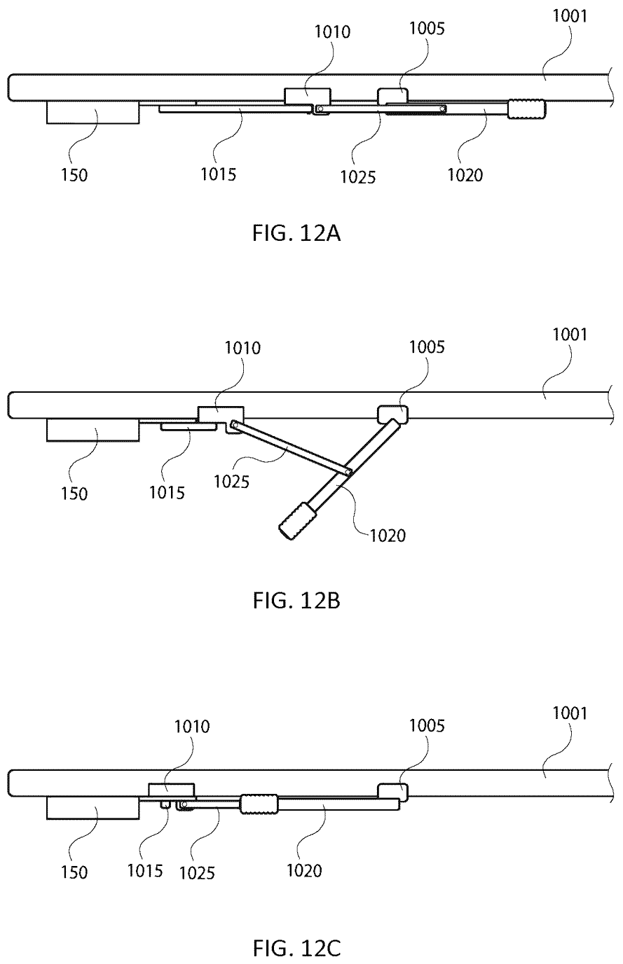

FIG. 10A, FIG. 10B, and FIG. 11 show side view illustrations of an example quick lift system for a truck bed rack 150. FIG. 12A, FIG. 12B, and FIG. 12C show top view illustrations of the example quick lift system.

A quick lift system, for example, includes a fixed pivot mount 1005 that can be secured with a channel in the truck bed rail 915 on the inside of a truck bed 1001. The fixed pivot mount 1005, for example, can be secured with the channel in the truck bed rail 915 using a screw or bolt. The fixed pivot mount 1005 may include a metal plate with a set screw that presses into the truck bed rail 915.

A quick lift system may include a slider 1010 pivotably coupled with a first end of a lifter arm 1015. A second end of the lifter arm 1015 may be coupled with or secured to the truck bed rack 150 such as, for example, with a bolt, nut, and/or bushing and/or with a detachable support or mount. One end of a handle 1020 may be pivotably coupled with the fixed pivot mount 1005 such that the handle 1020 can pivot outwardly from the fixed pivot mount 1005 while the fixed pivot mount 1005 does not move. A push member 1025 may be coupled with the handle 1020 and the slider 1010. A first end of the push member 1025 may be coupled with the handle 1020 and a second end of the push member 1025 may be coupled with the slider 1010.

As the handle 1020 swings outward away from the side of the truck bed 1001, the push member 1025 is pushed forward causing the slider 1010 to slide forward as shown in FIG. 10B and FIG. 12B. As the slider 1010, slides forward it pushes the lifter arm 1015 upward raising the lifter arm 1015 as shown in FIG. 11.

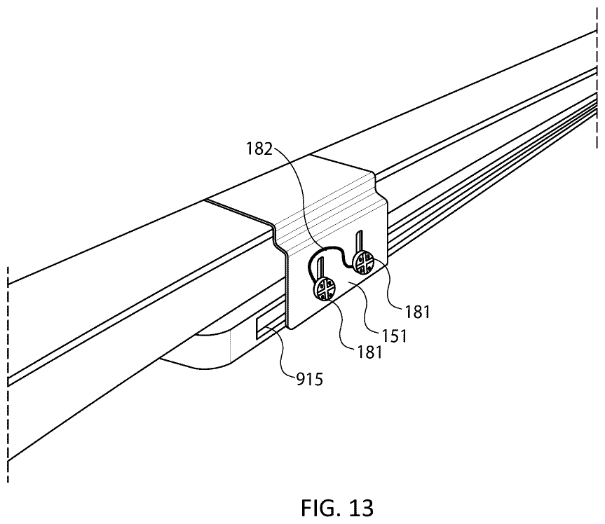

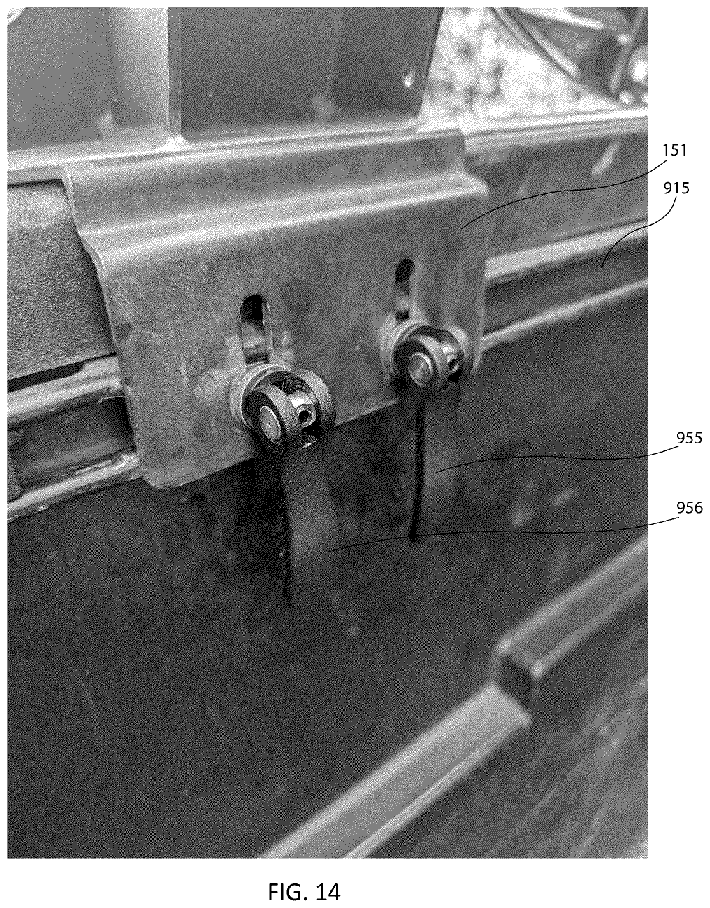

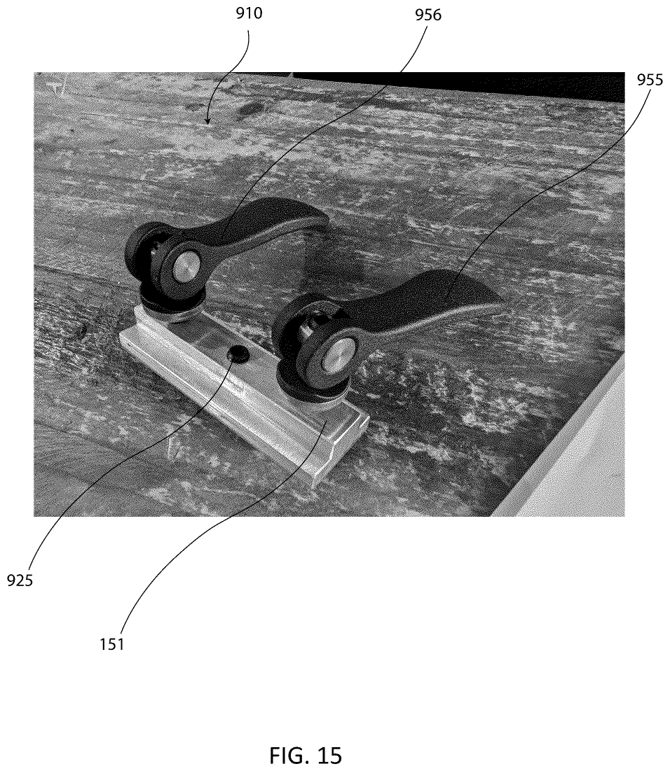

FIG. 13 is an illustration of an example quick release pin system used with a truck bed rail 915. FIG. 14 is an image of an example quick release system 910 used with a truck bed rail 915. FIG. 15 is an image of an example quick release system 910. A metal block 920 that is sized and configured to slide within the truck bed rail 915 may include a set screw 925 that when tightened engages with the back wall of the truck bed rail 915. A first quick release lever bolt 955 and a second quick release lever bolt 956 can be engaged to couple the bracket 151 with the truck bed rail 915.

As another example, a quick lift system for a truck bed rack may include a pneumatic lift (or hydraulic lift) system. A pneumatic lift may include a plurality of pneumatic cylinders or solenoids (or the like) attached with either or both the truck bed rail 915 and the truck bed 1001 on one end and the truck bed rack 150 on the other end. The pneumatic lift system may lift the truck bed rack 150 vertically. The pneumatic lift system may include one or more pumps or the like to pressurize pneumatic cylinders.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A truck rack lifter assembly for comprising:
an assembly frame;
one or more wheels coupled with the assembly frame; and
a plurality of lifter mechanisms coupled with the frame that are arranged to couple with a truck rack and lift the truck rack vertically.

2. A lever assembly comprising:
a vertical member;
a slider body;
a horizontal support member;
a lifter arm having tapered end, the lifter arm coupled with the slider body;
an angled support member coupled with the vertical member and the horizontal support member at a first attachment point;
a first lever arm rotatably coupled with the angled support member and the horizontal support member at the first attachment point, the first lever arm is coupled with the tapered end of the lifter arm; and
a second lever arm coupled with a first lever arm at a second attachment point.
